(19) United States
(12) Patent Application Publication
(10) Pub. No.: US 2005/0025235 A1
(43) Pub. Date: Feb. 3, 2005

(54) Method and system for overlaying image with text

(76) Inventors: Jack Hoang, Toronto (CA); Bin Jia, Toronto (CA)

Correspondence Address: DEETH WILLIAMS WALL LLP, 150 YORK STREET, SUITE 400, TORONTO, M5H 3S5, CA

(21) Appl. No.: 10/902,173

(22) Filed: Jul. 30, 2004

Related U.S. Application Data
(60) Provisional application No. 60/490,959, filed on Jul. 30, 2003.

(51) Int. Cl. H04N 7/12

(52) U.S. Cl. 375/240.01; 348/143; 348/150

(57) ABSTRACT

The present invention relates to overlaying video images with text, especially with images recorded on a Digital Video Recorder. A system is provided for managing video images recorded of a transaction by a digital video capture element using a transaction peripheral comprising: a video input buffer for receiving an image of the transaction from the transaction peripheral; a processor element for superimposing on the image text information received from the transaction peripheral relating to the transaction; a storage element for storing the superimposed image; and a database for linking the image and at least one detail of the transaction.

### CROSS-REFERENCE TO RELATED APPLICATION

This application claims the benefit under 35 USC §119(e) of the following patent application, the disclosure of which is hereby incorporated by reference thereto in its entirety: U.S. Ser. No. 60/490,959 filed Jul. 30, 2003.

### FIELD OF THE INVENTION

The present invention relates to overlaying video images with text, especially with images recorded on a Digital Video Recorder.

### BACKGROUND OF THE INVENTION

A device gaining acceptance are digital video recorders (DVR) or a digital video management systems (DVMS). The DVR contains (or is connectable to) at least one mass digital storage device such as a hard disk, CD-RW, or DVD-RW drive similar to those in computers for storing digital data. The DVR receives a video, either analog of digital in format, from a camera for example. For digital input, a DVR can digitize, compress, and store the resulting signal using onboard software and hardware. In the case of analog signals, the DVR can store the digital signal as received. The DVR can then retrieve and output the signal to a connected output device such as a video display terminal or even a computer. The DVR also permits a user to freeze, stop, fast/slow-forward and rewind the signal, in a similar fashion as a standard VCR. Advanced video searching may also be employed with event type and time indexing.

A DVMS typically includes but incorporates more elements than a DVR. The simultaneous input of more than one camera may be connected. A DVMS often includes or is coupled to elements necessary for a specific application of a DVR, including software for manipulating images on a computer being part of the DVMS. A DVMS server as a software program will typically have access to mass digital storage for the video signals, either residing at a DVR or at a computer connected to the DVR. In this document, the terms DVMS and DVR are used interchangeably unless otherwise noted.

Applications of the DVR technology include security surveillance and recording of specific commercial transactions. In the case of the latter, for example, a DVMS is coupled to a point of sales terminal and a video camera is connected. Subsequent confirmation of the taking place of a transaction may be provided for by the simultaneous display of the details of the transaction and the accompanying one or more video frames as recorded. There is a need to capture both transaction detail and image such as to minimize any doubt of a transaction mismatch, that is to say, the video frames of a transaction are incorrectly coupled to a different transaction.

### BRIEF SUMMARY OF THE INVENTION

In accordance with the present invention, a system is provided for managing video images recorded of a transaction by a digital video capture element using a transaction peripheral comprising: a video input buffer for receiving an image of the transaction from the transaction peripheral; a processor element for superimposing on the image text information received from the transaction peripheral relating to the transaction; a storage element for storing the superimposed image; and a database for linking the image and at least one detail of the transaction.

The system may further comprise an element for receiving an instruction to display at least one image based on a criteria; and a display device for displaying the at least one image.

The digital video capture element may be a digital video camera.

The video input buffer, the processor, the storage element, and the database may be parts of a server.

The transaction peripheral may be one chosen from the group consisting of a point-of-sales terminal, an automatic teller machine, and a card access unit.

The system of claim 1, wherein the transaction detail is one chosen form the group consisting of time of the image capture, identifying number of the transaction peripheral, and identifying number of the digital video capture element, and a receipt number of the transaction.

The system may further comprise a network communication device for communicating to a network.

The system may further comprise at least one display device for displaying the image.

The system may further comprise at least one user computer display device for displaying the image.

In a variation, the only changed portions of the image compared to a previous image are stored.

The image may be compressed for storage in a format chosen form the group consisting of JPEG, MPEG, TIFF and GIFF.

The system may further comprise storing an index file and a data file.

The intensity of the text superimposed at a pixel may be dependent on the original image pixel value.

The system may further comprise an element for permitting a user to submit a configuration change file to the system.

In accordance with a further aspect, this invention provides for a method for managing video images recorded of a transaction by a digital video capture element using a transaction peripheral comprising the steps of: receiving an image of the transaction from the transaction peripheral in a video input buffer; superimposing on the image text information received from the transaction peripheral relating to the transaction; storing the superimposed image in a storage element; and linking the image and at least one detail of the transaction in a database.

In a variation, the method further comprises receiving an instruction to display at least one image based on a criteria; and displaying the at least one image using a display device.

### BRIEF DESCRIPTION OF THE DRAWINGS

FIG. 1 illustrates one embodiment of the system;

FIG. 2 illustrates a second embodiment of the system; and

FIG. 3 is a flowchart of a text overlay and display process.

### DETAILED DESCRIPTION OF THE INVENTION

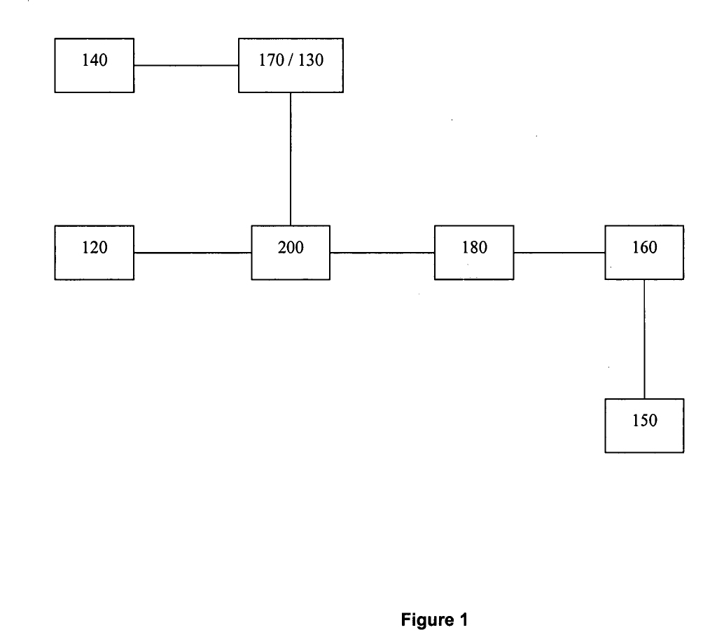

A DVMS of the present invention may operate as a standalone application system, or under external control such as by a further computer using a multiplexer or be part of a local area or wide-area network (such as the Internet). FIG. 1 shows one embodiment of the present invention using the example of a DVMS used in a commercial sales context. A transaction peripheral 120 (e.g. POS terminals such as a cash register, bank ABM machines, and security card access units) is connected to a peripheral server 180 (either directly or otherwise, typically through a network hub or a switch 200), which in turn has connected thereto a DVR 170 and video camera 140. The entire system 110 may be comprised of a network of peripheral server and user computers 180 160. As mentioned earlier, the DVR 170 has onboard digital storage for storing video images captured by the video camera 140 in a database. Typically, the video images are first relayed and stored temporarily on the DVR 170 for further transmission and long term storage in a database on a remote computer. Therefore, the mass storage device may be merely available to the DVR 170 and not necessarily onboard, such as through networked storage devices or a physically separate (DVMS) server 130.

The images stored may be displayed using one or more display devices 150 connected to a user computer 160 on the same network as the DVR 170 (or directly connected to the DVR 170 itself. The display device 150 may be a monitor or any kind of similar display devices, including those wirelessly connected to the user computer 160 such as a personal digital assistant.

Evidence of a typical transaction comes in two forms. First, there are the video images of the participants involved in the dealing for the transaction. For example, in the case of a retail sale, at least the person operating the POS terminal (cash register) 120, typically employed by the retailer, and the customer who initiates the request for the sale participate. The details of the sales, e.g. the identifier of the item or service purchased, the payment terms (cash, credit, debit card, etc.), the time and place of the transaction, the ID code of the cash register 120 and the sales person, involved, are captured by the cash register 120 and comprise the second type of evidence of the transaction. If the transaction involves a withdrawal from a bank account using an ABM machine 120, the only participant would be the customer and the transaction detail typically includes the account number, the amount withdrawn, the time of the transaction, and the ID code of the ABM machine 120.

For recording a transaction with a participant, the video camera 140 captures images of the transaction, in whole or in part, especially of the participant. The video signals from the camera 140 are transmitted to a DVR 170. The DVR 170 has onboard hardware and software for processing the video frames received from the camera 140 including the DVMS server 130. Each video image or frame is comprised of smaller “blocks” or pixels. For successive frames, the DVMS server 130 examines the frames for any change. If there is no difference between the two frames, then the subsequent frame is not saved; in the event of a change, only the difference (the change) between the two images is stored.

Simultaneously, information entered and results of processing by the transaction peripheral 120 is also sent to the DVR 170. This invention modifies the data arriving at video input buffer from a means for capturing the video data (such as a display card) at the DVR 170 to superimpose text, including the transaction-related information, in part or whole, from the transaction peripheral 120 onto the saved video images. The resulting video images are compressed for minimizing storage requirement into a file format, typically jpeg, but may include mpeg, tiff, and gif. Images are optionally watermarked, and/or digitally signed, using methods known in the art for such.

The DVMS server 130 also saves the data using a special index file and data file as a separate stream from the video data, which stores the transaction related information and video images, and matches these to each other using an optional database system. In a preferred embodiment, the data file records the frame pixels, frame time, and frame quality; the index file keeps pixel block general information (generally useful for later searching), such as block start position, start time, and duration. Frame quality may include such information as frame size (e.g. 160×120, 320×240 or 640×480 pixels).

In order to overlay a given frame with text, the text is regarded as a series of dots (or pixels). The screen position of each dot is calculated. The value of each pixel on the frame corresponding to a text dot element is modified. The modified value is typically set such that the pixel appears white (e.g. intensity 255 for a 0-to-255 range of greyscale intensity values). In a variation, the original value of the screen pixel prior to text pixel overlay is taken into consideration to determine the new intensity value. For example, if the original image pixel has high intensity, then the text overlaid pixel will be assigned a low intensity, and vice versa. In this fashion, a contrast may be created between the text as overlaid on the frame and its background.

After determining the location and intensity/colour for all the text pixels, the current link table is accessed for the frame changed blocks. The content of the link table is a series of pixel location, pixel colour, and pixel brightness. The text information can now be added to the frame link table.

For playback of a particular video sequence, the user can specify a detail of the transaction, such as time, camera number, receipt no., etc. The system (a remote program or a program at the server) retrieves information from the index file, locates the necessary data in the saved data file, and displays the data on a display device to the user.

The System may show the text during live mode presentation of images (newly captured frame, not yet saved to the server/disk) and search mode (frames already saved to server/disk), or only during search mode presentation of frames in a variation. If text is written before a frame is displayed on a screen, text can be seen on the screen in either modes. On the other hand, if text is written after the frame is displayed on screen but prior to saving of the video to disk, then the text information may be hidden during live mode presentation, and the text is displayed only in search mode.

If the DVMS server 130 has text information overlaid on the frames, then a remote program may then display the frames with the overlaid text.

In one embodiment, a user may configure a number of options, e.g. in a configuration file. These include camera number, enable/disable text display, text colour, start positions for x and y, maximum number of characters in one line, maximum number of lines for one camera, text scroll time, and text disappear time. A program may be included which allows the configuration to be changed by a human user.

The DVR server 130 may have multiple socket programs for receiving commands, either simultaneously or not, from connected peripheral units 120. For example, a POS 120 may issue commands to the DVR server 130 for displaying frames with text overlay on a particular screen.

In a variation, a command may be issued by a user to scroll through text overlaid on a single screen if the text data cannot fit on one screen for display. This way all the text of a certain font size and length may be viewed even if the text could not be seen all at once on the screen.

In further variations, the stored video images may be further processed with measures for copyright protection and authentication purposes, such as a watermark and a digital signature. These are clear to a person skilled in the art.

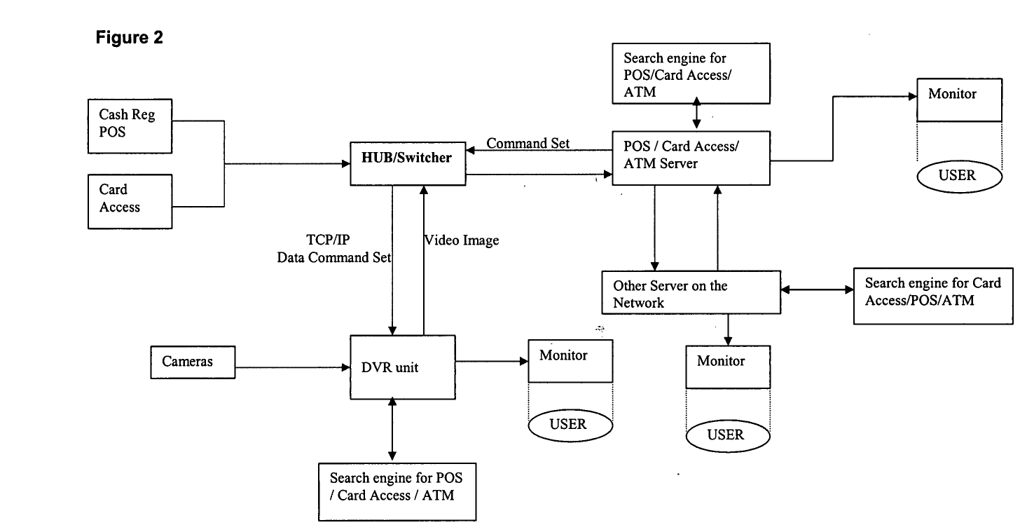

FIG. 2 shows a further embodiment with DVR integration with peripheral units.

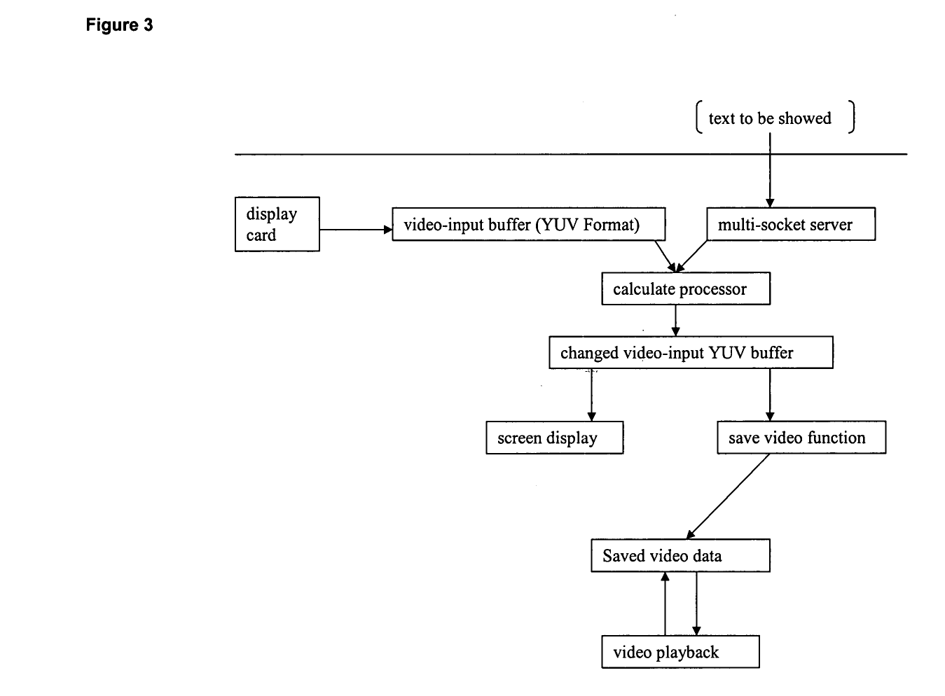

FIG. 3 is a flowchart of the text overlay and display process. Text to be shown is received by the DVMS server 130. Video input is received at a display card and placed in a video-input buffer in YUV format (other formats such as RGB and HSV are also possible). The text and video are then overlaid/processed by a processor which modifies the video-input buffer. At this point, the merged video and text can either be displayed and/or saved to long-term storage. Video playback of the stored video can later take place.

It will be appreciated that the above description relates to the preferred embodiments by way of example only. Many variations on the system and method for delivering the invention without departing from the spirit of same will be clear to those knowledgeable in the field, and such variations are within the scope of the invention as described and claimed, whether or not expressly described.

1. A system for managing video images recorded of a transaction by a digital video capture element using a transaction peripheral comprising:
a video input buffer for receiving an image of the transaction from the transaction peripheral;
a processor element for superimposing on the image text information received from the transaction peripheral relating to the transaction;
a storage element for storing the superimposed image; and
a database for linking the image and at least one detail of the transaction.

2. The system of claim 1, further comprising:
an element for receiving an instruction to display at least one image based on a criteria; and
a display device for displaying the at least one image.

3. The system of claim 1, wherein the digital video capture element is a digital video camera.

4. The system of claim 1, wherein the video input buffer, the processor, the storage element, and the database are parts of a server.

5. The system of claim 1, wherein the transaction peripheral is one chosen from the group consisting of a point-of-sales terminal, an automatic teller machine, and a card access unit.

6. The system of claim 1, wherein the transaction detail is one chosen form the group consisting of time of the image capture, identifying number of the transaction peripheral, and identifying number of the digital video capture element, and a receipt number of the transaction.

7. The system of claim 1, further comprising a network communication device for communicating to a network.

8. The system of claim 1, further comprising at least one display device for displaying the image.

9. The system of claim 1, further comprising at least one user computer display device for displaying the image.

10. The system of claim 1, wherein only changed portions of the image compared to a previous image are stored.

11. The system of claim 1, wherein the image is compressed for storage in a format chosen form the group consisting of JPEG, MPEG, TIFF and GIFF.

12. The system of claim 1, further comprising storing an index file and a data file.

13. The system of claim 1, wherein the intensity of the text superimposed at a pixel is dependent on the original image pixel value.

14. The system of claim 1, further comprising an element for permitting a user to submit a configuration change file to the system.

15. A method for managing video images recorded of a transaction by a digital video capture element using a transaction peripheral comprising the steps of:
receiving an image of the transaction from the transaction peripheral in a video input buffer;
superimposing on the image text information received from the transaction peripheral relating to the transaction;
storing the superimposed image in a storage element; and
linking the image and at least one detail of the transaction in a database.

16. The method of claim 15, further comprising the steps of:
for receiving an instruction to display at least one image based on a criteria; and
displaying the at least one image using a display device.

17. The method of claim 15, wherein only changed portions of the image compared to a previous image are stored.

18. The method of claim 15, wherein the step of storing the image comprises compressing the image in a format chosen form the group consisting of JPEG, MPEG, TIFF and GIFF.

19. The method of claim 15, further comprising storing an index file and a data file.

20. The method of claim 15, wherein the intensity of the text superimposed at a pixel is dependent on the original image pixel value.
